(19) United States
(12) Patent Application Publication
(10) Pub. No.: US 2003/0057294 A1
(43) Pub. Date: Mar. 27, 2003

(54) Atomiser

(75) Inventors: Graham Bank, Woodbridge (GB); Martin Colloms, London (GB); Neil Simon Owen, Huntingdon (GB); Neil Harris, Cambridge (GB); Martin Christopher Cassey, Cambridge (GB)

Correspondence Address: FOLEY AND LARDNER, SUITE 500, 3000 K STREET NW, WASHINGTON, DC, 20007, US

(73) Assignee: NEW TRANSDUCERS LIMITED

(21) Appl. No.: 10/201,638

(22) Filed: Jul. 24, 2002

Related U.S. Application Data
(63) Continuation-in-part of application No. 09/768,002, filed on Jan. 24, 2001.
(60) Provisional application No. 60/309,874, filed on Aug. 6, 2001.
(60) Provisional application No. 60/178,315, filed on Jan. 27, 2000.
(60) Provisional application No. 60/218,062, filed on Jul. 13, 2000.
(60) Provisional application No. 60/205,465, filed on May 19, 2000.

(30) Foreign Application Priority Data
Aug. 1, 2001 (GB) 0118756.6

(51) Int. Cl. B05B 1/08; B05B 3/04

(52) U.S. Cl. 239/102.2

(57) ABSTRACT

An atomiser comprising a fluid delivery system, a nozzle which is connected to and receives fluid from the fluid delivery system, whereby fluid is vaporised on exiting the nozzle to form an aerosol stream of fluid droplets, and a vibration assembly which comprises a member capable of supporting vibration which is positioned adjacent the nozzle and an electromechanical force transducer mounted to the member to excite vibration in the member so as to input vibrational energy into the droplets. The transducer has an intended operative frequency range and comprises a resonant element having a frequency distribution of modes in the operative frequency range.

This application claims the benefit of provisional application No. 60/309,874, filed Aug. 6, 2001 (incorporated by reference in its entirety) and is a continuation-in-part application of U.S. application Ser. No. 09/768,002 filed Jan. 24, 2001, which claims the benefit of U.S. provisional No. 60/178,315, filed Jan. 27, 2000; No. 60/205,465, filed May 19, 2000 and No. 60/218,062, filed Jul. 13, 2000.

### TECHNICAL FIELD

This invention relates to atomisers, for example, atomisers for use with fuel, drugs or atomisers which act as humidifiers.

### SUMMARY OF THE INVENTION

According to the invention, there is provided an atomiser comprising a fluid delivery system, a nozzle which is connected to and receives fluid from the fluid delivery system, whereby fluid is vaporised on exiting the nozzle to form an aerosol stream of fluid droplets, and a vibration assembly which comprises a member capable of supporting vibration which is positioned adjacent the nozzle and an electromechanical force transducer mounted to the member to excite vibration in the member so as to input vibrational energy into the droplets, characterised in that the transducer has an intended operative frequency range and comprises a resonant element having a frequency distribution of modes in the operative frequency range.

The member may be in the form of a panel-form radiator which may be capable of supporting bending wave vibration, for example resonant bending wave modes. The member may be positioned below the aerosol stream. The vibrating system may comprise coupling means for mounting the transducer to the member. The coupling means may be mounted to the resonant element.

Alternatively, the member may be in the form of a connecting stub which is mounted to the nozzle and transmits vibration to the nozzle. Thus according to a second aspect of the invention, there is provided an atomiser comprising a fluid delivery system, a nozzle which is connected to and receives fluid from the fluid delivery system, whereby fluid is vaporised on exiting the nozzle to form an aerosol stream of fluid droplets, and a vibration assembly which comprises an electromechanical force transducer mounted to the nozzle via a connecting stub to excite vibration in the nozzle so as to input vibrational energy into the fluid, the transducer having an intended operative frequency range and comprising a resonant element having a frequency distribution of modes in the operative frequency range. The connecting stub may be mounted on the resonant element.

For either embodiment, the fluid in the atomiser may be fuel, drugs or may be water so that the atomiser acts as a humidifier. The fluid delivery system may comprise a reservoir which is mounted within the atomiser.

The resonant element may be active e.g. may be a piezoelectric transducer and may be in the form of a strip of piezoelectric material. Alternatively, the resonant element may be passive and the transducer may further comprise an active transducer, e.g. an inertial or grounded vibration transducer, actuator or exciter, e.g. moving coil transducer. The active transducer may be a bender or torsional transducer (e.g. of the type taught in WO00/13464 and corresponding U.S. application Ser. No. 09/384,419). Furthermore, the transducer may comprise combination of passive and active elements to form a hybrid transducer.

A number of transducer, exciter or actuator mechanisms have been developed to input energy into an object, e.g. a fluid atomising device. There are various types of these transducer mechanisms, for example moving coil, moving magnet, piezoelectric or magnetostrictive types. Typically, coil and magnet type transducers lose 99% of their input energy to heat whereas a piezoelectric transducer may lose as little as 1%. Thus, piezoelectric transducers are popular because of their high efficiency.

There are several problems with piezoelectric transducers, for example, they are inherently very stiff, for example comparable to brass foil, and are thus difficult to match to a member, especially to the air. Raising the stiffness of the transducer moves the fundamental resonant mode to a higher frequency. Thus such piezoelectric transducers may be considered to have two operating ranges. The first operating range is below the fundamental resonance of the transducer. This is the “stiffness controlled” range where velocity rises with frequency and the output response usually needs equalisation. This leads to a loss in available efficiency. The second range is the resonance range beyond the stiffness range, which is generally avoided because the resonances are rather fierce.

Moreover, general teaching is to suppress resonances in a transducer, and thus piezoelectric transducers are generally used only used in the frequency range below or at the fundamental resonance of the transducers. Where piezoelectric transducers are used above the fundamental resonance frequency it is frequently necessary to apply damping to suppress resonance peaks.

The problems associated with piezoelectric transducers similarly apply to transducers comprising other “smart” materials, i.e. magnetostrictive, electrostrictive, and electret type materials. Various piezoelectric transducers are also known, for example as described in EP 0993 231A of Shinsei Corporation, EP 0881 856A of Shinsei Corporation, U.S. Pat. No. 4,593,160 of Murata Manufacturing Co. Limited, U.S. Pat. No. 4,401,857 of Sanyo Electric Co Limited, U.S. Pat. No. 4,481,663 of Altec Corporation and UK patent application GB2,166,022A of Sawafuji. However, it is an object of the invention to employ an improved transducer.

The transducer used in the present invention may be considered to be an intendedly modal transducer. The coupling means may be attached to the resonant element at a position which is beneficial for coupling modal activity of the resonant element to the interface. The parameters, e.g. aspect ratio, bending stiffness, thickness and geometry, of the resonant element may be selected to enhance the distribution of modes in the resonant element in the operative frequency range. The bending stiffness and thickness of the resonant element may be selected to be isotropic or anisotropic. The variation of bending stiffness and/or thickness may be selected to enhance the distribution of modes in the resonant element. Analysis, e.g. computer simulation using FEA or modelling, may be used to select the parameters.

The distribution may be enhanced by ensuring a first mode of the active element is near to the lowest operating frequency of interest. The distribution may also be enhanced by ensuring a satisfactory, e.g. high, density of modes in the operative frequency range. The density of modes is preferably sufficient for the active element to provide an effective mean average force which is substantially constant with frequency. Good energy transfer may provide beneficial smoothing of modal resonances. Alternatively, or additionally, the distribution of modes may be enhanced by distributing the resonant bending wave modes substantially evenly in frequency, i.e. to smooth peaks in the frequency response caused by “bunching” or clustering of the modes. Such a transducer may thus be known as a distributed mode transducer or DMT.

Such an intendedly modal or distributed mode transducer is described in International patent application WO 01/54450 and corresponding U.S. application Ser. No. 09/768,002 published as US-2001-0033669-A1 (the latter of which is herein incorporated by reference in its entirety).

The transducer may comprise a plurality of resonant elements each having a distribution of modes, the modes of the resonant elements being arranged to interleave in the operative frequency range and thus enhance the distribution of modes in the transducer as a whole device. The resonant elements may have different fundamental frequencies and thus, the parameters, e.g. loading, geometry or bending stiffness of the resonant elements may be different.

The resonant elements may be coupled together by connecting means in any convenient way, e.g. on generally stiff stubs, between the elements. The resonant elements are preferably coupled at coupling points which enhance the modality of the transducer and/or enhance the coupling at the site to which the force is to be applied. Parameters of the connecting means may be selected to enhance the modal distribution in the resonant element. The resonant elements may be arranged in a stack. The coupling points may be axially aligned.

The resonant element may be plate-like or may be curved out of planar. A plate-like resonant element may be formed with slots or discontinuities to form a multi-resonant system. The resonant element may be in the shape of a beam, trapezoidal, hyperelliptical or may be generally disc shaped. Alternatively, the resonant element may be rectangular and may be curved out of the plane of the rectangle about an axis along the short axis of symmetry.

The resonant element may be modal along two substantially normal axes, each axis having an associated fundamental frequency. The ratio of the two fundamental frequencies may be adjusted for best modal distribution, e.g. 9:7 (˜1.286:1).

As examples, the arrangement of such modal transducer may be any of: a flat piezoelectric disc; a combination of at least two or preferably at least three flat piezoelectric discs; two coincident piezoelectric beams; a combination of multiple coincident piezoelectric beams; a curved piezoelectric plate; a combination of multiple curved piezoelectric plates or two coincident curved piezoelectric beams.

The interleaving of the distribution of the modes in each resonant element may be enhanced by optimising the frequency ratio of the resonant elements, namely the ratio of the frequencies of each fundamental resonance of each resonant element. Thus, the parameter of each resonant element relative to one another may be altered to enhance the overall modal distribution of the transducer.

When using two active resonant elements in the form of beams, the two beams may have a frequency ratio (i.e. ratio of fundamental frequency) of 1.27:1. For a transducer comprising three beams, the frequency ratio may be 1.315:1.147:1. For a transducer comprising two discs, the frequency ratio may be 1.1+/−0.02 to 1 to optimise high order modal density or may be 3.2 to 1 to optimise low order modal density. For a transducer comprising three discs, the frequency ratio may be 3.03:1.63:1 or may be 8.19:3.20:1.

The parameters of the coupling means may be selected to enhance the distribution of modes in the resonant element in the operative frequency range. The coupling means may be vestigial, e.g. a controlled layer of adhesive.

The coupling means may be positioned asymmetrically with respect to the panel so that the transducer is coupled asymmetrically. The asymmetry may be achieved in several ways, for example by adjusting the position or orientation of the transducer with respect to axes of symmetry in the panel or the transducer.

The coupling means may form a line of attachment. Alternatively, the coupling means may form a point or small local area of attachment where the area of attachment is small in relation to the size of the resonant element. The coupling means may be in the form of a stub and have a small diameter, e.g. 3 to 4 mm. The coupling means may be low mass.

The coupling means may comprise more than one coupling point and may comprise a combination of points and/or lines of attachment. For example, two points or small local areas of attachment may be used, one positioned near centre and one positioned at the edge of the active element. This may be useful for plate-like transducers which are generally stiff and have high natural resonance frequencies.

Alternatively only a single coupling point may be provided. This may provide the benefit, in the case of a multi-resonant element array, that the output of all the resonant elements is summed through the single coupling means so that it is not necessary for the output to be summed by the load. The coupling means may be chosen to be located at an anti-node on the resonant element and may be chosen to deliver a constant average force with frequency. The coupling means may be positioned away from the centre of the resonant element.

The position and/or the orientation of the line of attachment may be chosen to optimise the modal density of the resonant element. The line of attachment is preferably not coincident with a line of symmetry of the resonant element. For example, for a rectangular resonant element, the line of attachment may be offset from the short axis of symmetry (or centre line) of the resonant element. The line of attachment may have an orientation which is not parallel to a symmetry axis of the panel.

The shape of the resonant element may be selected to provide an off-centre line of attachment which is generally at the centre of mass of the resonant element. One advantage of this embodiment is that the transducer is attached at its centre of mass and thus there is no inertial imbalance. This may be achieved by an asymmetric shaped resonant element which may be in the shape of a trapezium or trapezoid.

For a transducer comprising a beam-like or generally rectangular resonant element, the line of attachment may extend across the width of the resonant element. The area of the resonant element may be small relative to that of the member.

The member may be in the form of a panel. The panel may be flat and may be lightweight. The material of the member may be anisotropic or isotropic.

The member may support bending wave vibration, or particularly resonant bending wave vibration. The member may have a distribution of resonant bending wave modes and the properties of the member may be chosen to distribute the resonant bending wave modes substantially evenly in frequency, i.e. to smooth peaks in the frequency response caused by “bunching” or clustering of the modes.

In particular, the properties of the member may be chosen to distribute the lower frequency resonant bending wave modes substantially evenly in frequency. The lower frequency resonant bending wave modes are preferably the ten to twenty lowest frequency resonant bending wave modes of the member.

The transducer location may be chosen to couple substantially evenly to the resonant bending wave modes in the member, in particular to lower frequency resonant bending wave modes. In other words, the transducer may be mounted at a location where the number of vibrationally active resonance anti-nodes in the member is relatively high and conversely the number of resonance nodes is relatively low. Any such location may be used, but the most convenient locations are the near-central locations between 38% to 62% along each of the length and width axes of the member, but off-centre. Specific or preferential locations are at 3/7, 4/9 or 5/13 of the distance along the axes; a different ratio for the length axis and the width axis is preferred. Preferred is 4/9 length, 3/7 width of an isotropic panel having an aspect ratio of 1:1.13 or 1:1.41.

The operative frequency range may be over a relatively broad frequency range. Each different size of droplet responds to the input vibrational energy from a different frequency. Thus operation over a relatively broad frequency range allows a broad range of droplets to be produced or kept suspended in the aerosol stream. In contrast, if the transducer only operated at a single frequency, i.e. its dominant natural resonant mode, it would be necessary to change the transducer and hence retune the atomiser for different sizes of droplets. Using a broad band transducer may also allow the signal applied to the transducer to be adapted to produce or keep particular, predetermined droplets suspended by altering the frequency of the vibrations in the member.

The operative frequency range may be in the audio range and/or ultrasonic range. Thus, operation over a range greater than the range defined by a single dominant, natural resonance of the transducer may be achieved. The lowest frequency in the operative frequency range is preferably above a predetermined lower limit which is about the fundamental resonance of the transducer.

For example, for a beam-like active resonant element, the force may be taken from the centre of the beam, and may be matched to the mode shape in the member to which it is attached. In this way, the action and reaction may co-operate to give a constant output with frequency. By connecting the resonant element to the member at an anti-node of the resonant element, the first resonance of the resonant, element may appear to be a low impedance. In this way, the member should not amplify the resonance of the resonant element.

### BRIEF DESCRIPTION OF DRAWINGS

Examples that embody the best mode for carrying out the invention are described in detail below and are diagrammatically illustrated in the accompanying drawings in which:

FIG. 1A is a cross-section through a first atomiser according to the present invention;

FIG. 1B is a cross-section through a second atomiser according to the present invention;

FIGS. 2 to 8 are side views of modal transducers according to the present invention;

FIG. 9 is a plan view of an alternative modal transducer according to in the present invention;

FIG. 10A is a schematic plan view of a parameterised model of a transducer according to the present invention;

FIG. 10B is a section perpendicular to the line of attachment of the transducer of FIG. 10A;

FIG. 11A is a schematic plan view of a parameterised model of a transducer according to the present invention and

FIG. 11B is a section perpendicular to the line of attachment of the transducer of FIG. 11A.

### DETAILED DESCRIPTION

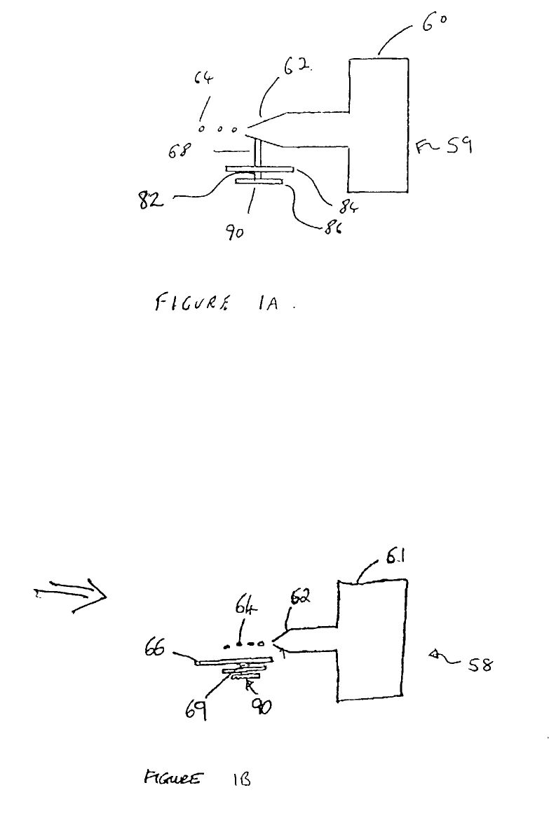

FIG. 1A shows an atomiser (59) comprising a delivery system or reservoir (60) holding fluid, e.g. water, fuel or medicine, and a nozzle (62) which is fed with fluid under pressure from the delivery system. An intendedly modal transducer (90) or distributed mode transducer as hereinbefore described and as described in WO01/54450 and corresponding U.S. application Ser. No. 09/768,002, is mounted to a coupling means (68) in the form of a stub which is connected to the nozzle (62). The transducer (90) induces vibration in the stub which is transmitted to the nozzle. The vibration in the nozzle imparts additional energy into the fluid as it exits the nozzle aiding and influencing the process of droplet (64) formation.

The distributed mode transducer (90) comprises upper and lower bimorph beams (84) and (86) which are connected by a stub (82). The upper beam (84) is connected to the coupling means (68) which extends across the width of the beams. The stub may be 1-2 mm wide and high and may be made from hard plastics and/or metal with suitable insulating layers to prevent electrical short circuits.

The beams are of unequal lengths with the upper beam (84) of length 36 mm being longer than the lower beam (86) of length 32 mm. Both beams have a width 7.5 mm and a weight of 1.6 grams. Each beam consists of three layers, namely two outer layers of piezoelectric ceramic material, e.g. PZT 5H, sandwiching a central brass vane. The outer layers may have a thickness of 150 microns and the central vane, a thickness of 100 microns. The outer layers may be attached to the brass vane by adhesive layers which are typically 10-15 microns in thickness.

FIG. 1B shows an atomiser (58) comprising a reservoir (61) holding fluid, e.g. water, fuel or medicine, and a nozzle (62) which is fed with fluid under pressure from the delivery system. On contact with the atmosphere, the fluid vaporises and exits the nozzle (62) in a stream of fluid droplets (64). The droplets pass over a panel (66) which is a vibrating surface. An intendedly modal transducer (90) or distributed mode transducer as is in FIG. 1A, is mounted to coupling means in the form of a short stub (69) which is connected to the panel (66). The transducer (90) induces vibration in the panel (66) so that the droplets remain buoyant.

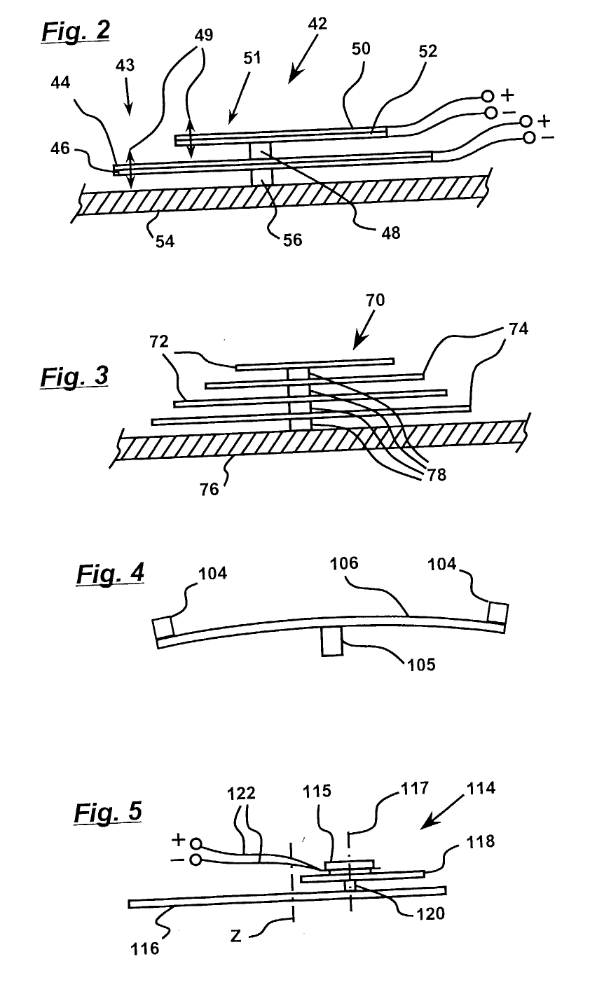

FIGS. 2 to 11B show a variety of transducers which may be adapted for use in the atomiser of FIG. 1.

FIG. 2 shows a transducer (42) which comprises a first piezoelectric beam (43) on the back of which is mounted a second piezoelectric beam (51) by connecting means in the form of a stub (48) located at the centre of both beams. Each beam is a bi-morph. The first beam (43) comprises two layers (44,46) of piezoelectric material and the second beam (51) comprises two layers (50,52). The poling directions of each layer of piezoelectric material are shown by arrows (49). Each layer (44, 50) has an opposite poling direction to the other layer (46, 52) in the bi-morph. The bi-morph may also comprise a central conducting vane which allows a parallel electrical connection as well as adding a strengthening component to the ceramic piezoelectric layers. Each layer of each beam (44, 46) may be made of the same/different piezoelectric material. Each layer is generally of a different length.

The first piezoelectric beam (43) is mounted on a panel (54) by coupling means in the form of a stub (56) located at the centre of the first beam. By mounting the first beam at its centre only the even order modes will produce output. By locating the second beam behind the first beam, and coupling both beams centrally by way of a stub they can both be considered to be driving the same axially aligned or co-incident position.

When elements are joined together, the resulting distribution of modes is not the sum of the separate sets of frequencies, because each element modifies the modes of the other. The two beams are designed so that their individual modal distributions are interleaved to enhance the overall modality of the transducer. The two beams add together to produce a useable output over a frequency range of interest. Local narrow dips occur because of the interaction between the piezoelectric beams at their individual even order modes.

The second beam may be chosen by using the ratio of the fundamental resonance of the two beams. If the materials and thicknesses are identical, then the ratio of frequencies is just the square of the ratio of lengths. If the higher f0 (fundamental frequency) is simply placed half way between f0 and f1 of the other, larger beam, f3 of the smaller beam and f4 of the lower beam coincide.

Plotting a graph of a cost function against ratio of frequency for two beams shows that the ideal ratio is 1.27:1, namely where the cost function is minimised at point. This ratio is equivalent to the “golden” aspect ratio (ratio of f02:f20) described in WO97/09842 and corresponding U.S. Pat. No. 6,332,029. The method of improving the modality of a transducer may be extended by using three piezoelectric beams in the transducer. The ideal ratio is 1.315:1.147:1.

The method of combining active elements, e.g. beams, may be extended to using piezoelectric discs. Using two discs, the ratio of sizes of the two discs depends upon how many modes are taken into consideration. For high order modal density, a ratio of fundamental frequencies of about 1.1+/−0.02 to 1 may give good results. For low order modal density (i.e. the first few or first five modes), a ratio of fundamental frequencies of about 3.2:1 is good. The first gap comes between the second and third modes of the larger disc.

Since there is a large gap between the first and second radial modes in each disc, much better interleaving is achieved with three rather than with two discs. When adding a third disc to the double disc transducer, the obvious first target is to plug the gap between the second and third modes of the larger disc of the previous case. However, geometric progression shows that this is not the only solution. Using fundamental frequencies of f0, α.f0 and 60 ².f0, and plotting rms(α.α²) there exist two principal optima for α. The values are about 1.72 and 2.90, with the latter value corresponding to the obvious gap-filling method.

Using fundamental frequencies of f0, α.f0 and β.f0 so that both scalings are free and using the above values of α as seed values, slightly better optima are achieved. The parameter pairs (α.β . . . are (1.63, 3.03) and (3.20, 8.19). These optima are quite shallow, meaning that variations of 10%, or even 20%, in the parameter values are acceptable.

An alternative approach for determining the different discs to be combined is to consider the cost as a function of the ratio of the radii of the three discs. The cost functions may be RSCD (ratio of sum of central differences), SRCD (sum of the ratio of central differences) and SCR (sum of central ratios). For a set of modal frequencies, f₀, f₁, fₙ, . . . f_{N}, these functions are defined as:

$$\begin{matrix} RSCD ( R sum CD ) \text{:} \\ RSCD = \frac{\frac{1}{N - 1} {\sum }_{n = 1}^{N - 1} {( {f}_{n + 1} + {f}_{n - 1} - 2 {f}_{n} )}^{2}}{{f}_{0}} \\ SCRD ( sum RCD ) \text{:} \\ SRCD = \frac{1}{N - 1} {\sum }_{n = 1}^{N - 1} {( \frac{{f}_{n + 1} + {f}_{n - 1} - 2 {f}_{n}}{{f}_{n}} )}^{2} \\ CR \text{:} \\ SCR = \frac{1}{N - 1} {\sum }_{n = 1}^{N - 1} ( \frac{{f}_{n + 1} \cdot {f}_{n - 1}}{{( {f}_{n} )}^{2}} )\end{matrix}$$

The optimum radii ratio, i.e. where the cost function is minimised, is 1.3 for all cost functions. Since the square of the radii ratio is equal to the frequency ratio, for these identical material and thickness discs, the results of 1.3*1.3=1.69 and the analytical result of 1.67 are in good agreement.

Alternatively or additionally, passive elements may be incorporated into the transducer to improve its overall modality. The active and passive elements may be arranged in a cascade. FIG. 3 shows a multiple disc transducer (70) comprising two active piezoelectric elements (72) stacked with two passive resonant elements (74), e.g. thin metal plates so that the modes of the active and passive elements are interleaved.

The elements are connected by connecting means in the form of stubs (78) located at the centre of each active and passive element. The elements are arranged concentrically. Each element has different dimensions with the smallest and largest discs located at the top and bottom of the stack, respectively. The transducer (70) is mounted on a load device (76), e.g. a panel, by coupling means in the form of a stub (78) located at the centre of the first passive device which is the largest disc.

The method of improving the modality of a transducer may be extended to a transducer comprising two active elements in the form of piezoelectric plates. Two plates of dimensions (1 by α) and (α by α²) are coupled at (3/7, 4/9). The frequency ratio is therefore about 1.3:1 (1.14×1.14=1.2996).

As shown in FIG. 4, small masses (104) may be mounted at the end of the piezoelectric transducer (106) having coupling means (105). In FIG. 5, the transducer (114) is an inertial electrodynamic moving coil exciter, e.g. as described in WO97/09842 and corresponding U.S. Pat. No. 6,332,029, having a voice coil forming an active element (115) and a passive resonant element in the form of a modal plate (118). The active element (115) is mounted on the modal plate (118) and off-centre of the modal plate.

The modal plate (118) is mounted on the panel (116) by a coupler (120). The coupler is aligned with the axis (117) of the active element but not with the axis (Z) normal to the plane of the panel (116). Thus the transducer is not coincident with the panel axis (Z). The active element is connected to an electrical signal input via electrical wires (122). The modal plate (118) is perforate to reduce the acoustic radiation therefrom and the active element is located off-centre of the modal plate (118), for example, at the optimum mounting position, i.e. (3/7, 4/9).

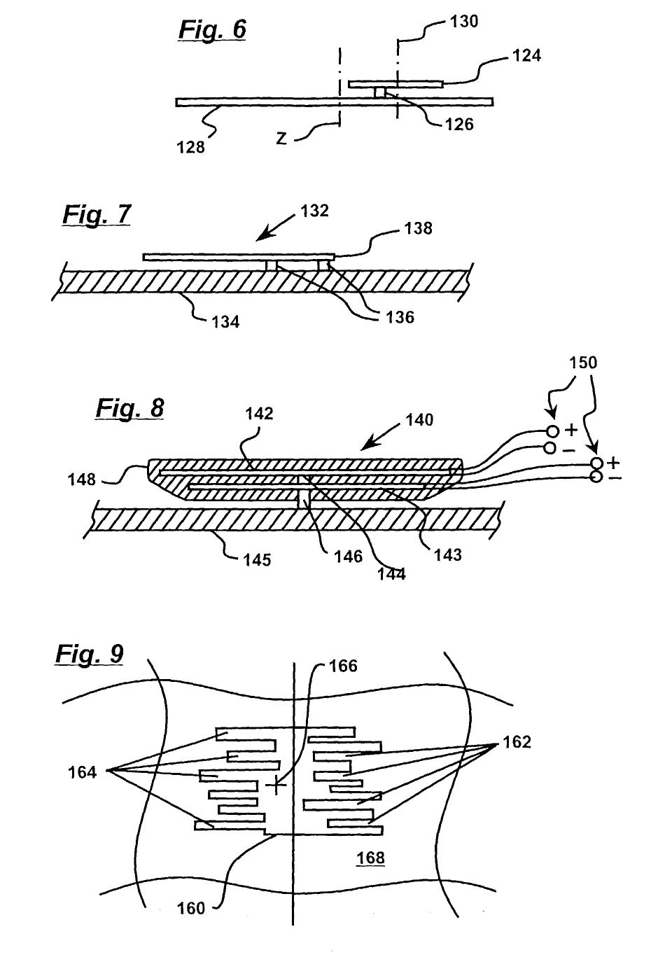

FIG. 6 shows a transducer (124) comprising an active piezoelectric resonant element which is mounted by coupling means (126) in the form of a stub to a panel (128). Both the transducer (124) and panel (128) have ratios of width to length of 1:1.13. The coupling means (126) is not aligned with any axes (130, Z) of the transducer or the panel. Furthermore, the placement of the coupling means is located at the optimum position, i.e. off-centre with respect to both the transducer (124) and the panel (128).

FIG. 7 shows a transducer (132) in the form of active piezoelectric resonant element in the form of a beam. The transducer (132) is coupled to a panel (134) by two coupling means (136) in the form of stubs. One stub is located towards an end (138) of the beam and the other stub is located towards the centre of the beam.

FIG. 8 shows a transducer (140) comprising two active resonant elements (142,143) coupled by connecting means (144) and an enclosure (148) which surrounds the connecting means (144) and the resonant elements (142). The transducer is thus made shock and impact resistant. The enclosure is made of a low mechanical impedance rubber or comparable polymer so as not to impede the transducer operation. If the polymer is water resistant, the transducer (140) may be made waterproof.

The upper resonant element (142) is larger than the lower resonant element (143) which is coupled to a panel (145) via a coupling means in the form of a stub (146). The stub is located at the centre of the lower resonant element (143). The power couplings (150) for each active element extend from the enclosure to allow good audio attachment to a load device (not shown).

FIG. 9 shows a transducer (160) in the form of a plate-like active resonant element. The resonant element is formed with slots (162) which define fingers (164) and thus form a multi-resonant system. The resonant element is mounted on a panel (168) by a coupling means in the form of a stub (166).

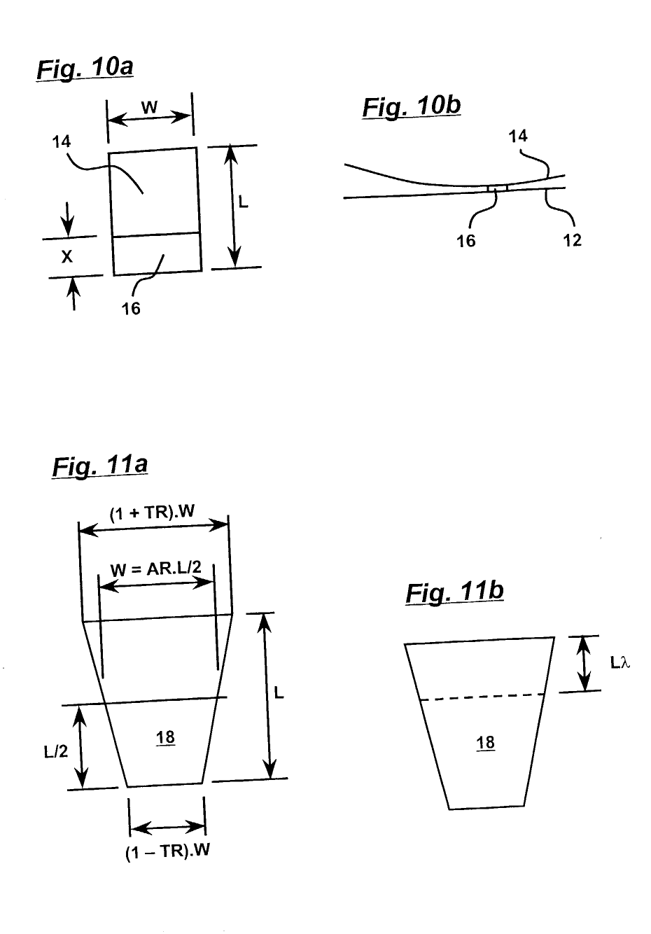

In FIGS. 10A and 10B, the transducer (14) is rectangular with out-of-plane curvature and is a pre-stressed piezoelectric transducer of the type disclosed in U.S. Pat. No. 5,632,841 (International patent application WO 96/31333) and produced by PAR Technologies Inc under the trade name NASDRIV. Thus the transducer (14) is an active resonant element. The transducer has width (W) and length (L) and the position (x) of the attachment point (16).

The curvature of the transducer (14) means that the coupling means (16) is in the form of a line of attachment. When the transducer is mounted along a line of attachment along the short axis through the centre, the resonance frequencies of the two arms of the transducer are coincident. The optimum suspension point may be modelled and has the line of attachment at 43% to 44% along the length of the resonant element. The cost function (or measure of “badness”) is minimised at this value; this corresponds to an estimate for the attachment point at 4/9ths of the length. Furthermore, computer modelling showed this attachment point to be valid for a range of transducer widths. A second suspension point at 33% to 34% along the length of the resonant element also appears suitable.

By plotting a graph of cost (or rms central ratio) against aspect ratio (AR=W/2L) for a resonant element mounted at 44% along its length, the optimum aspect ratio may be determined to be 1.06+/−0.01 to 1 since the cost function is minimised at this value.

The optimum angle of attachment θ to the panel (12) may be determined using two “measures of badness” to find the optimum angle. For example, the standard deviation of the log (dB) magnitude of the response is a measure of “roughness”. Such figures of merit/badness are discussed in International Application WO 99/41939 and corresponding U.S. application Ser. No. 09/246,967, to the present applicants. For an optimised transducer, namely one with aspect ratio 1.06:1 and attachment point at 44% using modelling, rotation of the line of attachment (16) will have a marked effect since the attachment position is not symmetrical. There is a preference for an angle of about 270°, i.e. with the longer end facing left.

FIGS. 11A and 11B show an asymmetrically shaped transducer (18) in the form of a resonant element having a trapezium shaped cross-section. The shape of a trapezium is controlled by two parameters, AR (aspect ratio) and TR (taper ratio). AR and TR determine a third parameter, X, such that some constraint is satisfied—for example, equal mass either side of the line.

The constraint equation for equal mass (or equal area) is as, follows;

$${\int }_{0}^{λ} ( 1 + 2 TR ( \frac{1}{2} - ξ ) ) ⅆ ξ = {\int }_{λ}^{1} ( 1 + 2 TR ( \frac{1}{2} - ξ ) ) ⅆ ξ$$

The above may readily be solved for either TR or λ as the dependent variable, to give:

$$TR = \frac{1 - 2 λ}{2 λ ( 1 - λ )} or λ = \frac{1 + TR - \sqrt{1 + {TR}^{2}}}{2 TR} \approx \frac{1}{2} - \frac{TR}{4}$$

Equivalent expressions are readily obtained for equalising the moments of inertia, or for minimising the total moment of inertia.

The constraint equation for equal moment of inertia (or equal 2^{nd} moment of area) is as follows;

$${\int }_{0}^{λ} ( 1 + 2 TR ( \frac{1}{2} - ξ ) ) {( λ - ξ )}^{2} ⅆ ξ = {\int }_{λ}^{1} ( 1 + 2 TR ( \frac{1}{2} - ξ ) ) {( ξ - λ )}^{2} ⅆ ξ$$

$$TR = \frac{( {λ}^{2} - λ + 1 ) ( 2 λ - 1 )}{2 {λ}^{4} - 4 {λ}^{3} + 2 λ - 1} or λ \approx \frac{1}{2} - \frac{TR}{8}$$

The constraint equation for minimum total moment of inertia is

$$\frac{ⅆ}{ⅆ λ} ( {\int }_{0}^{1} ( 1 + 2 TR ( \frac{1}{2} - ξ ) ) {( λ - ξ )}^{2} ⅆ ξ ) = 0$$

$$TR = 3 - 6 λ or λ = \frac{1}{2} - \frac{TR}{6}$$

A cost function (measure of “badness”) was plotted for the results of 40 FEA runs with AR ranging from 0.9 to 1.25, and TR ranging from 0.1 to 0.5, with λ constrained for equal mass. The transducer is thus mounted at the centre of mass. The results are tabulated below and show that there is an optimum shape with AR=1 and TR=0.3, giving λ at close to 43%.

| tr | λ | 0.9 | 0.95 | 1 | 1.05 | 1.1 | 1.15 | 1.2 | 1.25 |
|---|---|---|---|---|---|---|---|---|---|
| 0.1 | 47.51% | 2.24% | 2.16% | 2.16% | 2.24% | 2.31% | 2.19% | 2.22% | 2.34% |
| 0.2 | 45.05% | 1.59% | 1.61% | 1.56% | 1.57% | 1.50% | 1.53% | 1.66% | 1.85% |
| 0.3 | 42.66% | 1.47% | 1.30% | 1.18% | 1.21% | 1.23% | 1.29% | 1.43% | 1.59% |
| 0.4 | 40.37% | 1.32% | 1.23% | 1.24% | 1.29% | 1.25% | 1.29% | 1.38% | 1.50% |
| 0.5 | 38.20% | 1.48% | 1.44% | 1.48% | 1.54% | 1.56% | 1.58% | 1.60% | 1.76% |

One advantage of a trapezoidal transducer is thus that the transducer may be mounted along a line of attachment which is at its centre of gravity/mass but is not a line of symmetry. Such a transducer would thus have the advantages of improved modal distribution, without being inertially unbalanced. The two methods of comparison used previously again select 270° to 300° as the optimum angle of orientation.

The transducer used in the present invention may be seen as the reciprocal of a distributed mode panel, e.g. as described in WO97/09842 and corresponding U.S. Pat. No. 6,332,029, in that the transducer is designed to be a distributed mode object.

It should be understood that this invention has been described by way of examples only and that a wide variety of modifications can be made without departing from the scope of the invention as described in the accompanying claims.

1. An atomiser, comprising:
a fluid delivery system,
a nozzle which is connected to and receives fluid from the fluid delivery system, whereby fluid is vaporised on exiting the nozzle to form an aerosol stream of fluid droplets, and
a vibration assembly which comprises
a member capable of supporting vibration which is positioned adjacent the nozzle and
an electromechanical force transducer mounted to the member to excite vibration in the member so as to input vibrational energy into the droplets, wherein the transducer has an intended operative frequency range and comprises a resonant element having a frequency distribution of modes in the operative frequency range.

2. An atomiser according to claim 1, wherein the parameters of the resonant element are selected to enhance the distribution of modes in the resonant element in the operative frequency range.

3. An atomiser according to claim 2, wherein the resonant element is active and the distribution of modes in the resonant element has a density of modes which is sufficient for the resonant element to provide an effective mean average force which is substantially constant with frequency.

4. An atomiser according to claim 2, wherein the modes are distributed substantially evenly over the intended operative frequency range.

5. An atomiser according to claim 1, wherein the resonant element is modal along two substantially normal axes, each axis having an associated fundamental frequency and the ratio of the two associated fundamental frequencies being adjusted for best modal distribution.

6. An atomiser according to claim 5, wherein the ratio of the two fundamental frequencies is about 9:7.

7. An atomiser according to claim 1, wherein the transducer comprises a plurality of resonant elements each having a distribution of modes, the modes of the resonant elements being arranged to interleave in the operative frequency range whereby the distribution of modes in the transducer as a whole device is enhanced.

8. An atomiser according to claim 1, wherein the resonant element is plate-like.

9. An atomiser according to claim 1, wherein the shape of the resonant element is selected from the group consisting of beam-like, trapezoidal, hyperelliptical, generally disc shaped and rectangular.

10. An atomiser according to claim 9, wherein the resonant element is plate-like.

11. An atomiser according to claim 1, wherein the member is in the form of a panel-form radiator which is capable of supporting bending wave vibration.

12. An atomiser according to claim 11, wherein the member is positioned below the aerosol stream.

13. An atomiser according to claim 11, wherein the parameters of the resonant element are selected to enhance the distribution of modes in the resonant element in the operative frequency range.

14. An atomiser according to claim 13, wherein the distribution of modes in the resonant element has a density of modes which is sufficient for the resonant element to provide an effective mean average force which is substantially constant with frequency.

15. An atomiser according to claim 13, wherein the modes are distributed substantially even over the intended operative frequency range.

16. An atomiser according to claim 1, wherein the member is in the form of a connecting stub which is mounted to the nozzle and transmits vibration to the nozzle.

17. An atomiser according to claim 16, wherein the parameters of the resonant element are selected to enhance the distribution of modes in the resonant element in the operative frequency range.

18. An atomiser according to claim 17, wherein the distribution of modes in the resonant element has a density of modes which is sufficient for the resonant element to provide an effective mean average force which is substantially constant with frequency.

19. An atomiser according to claim 17, wherein the modes are distributed substantially even over the intended operative frequency range.

20. An atomiser according to claim 1, wherein the fluid in the atomiser is selected from the group consisting of fuel, drugs and water.

21. An atomiser according to claim 1, wherein the fluid delivery system comprises a reservoir which is mounted within the atomiser.

22. An atomiser, comprising:
a fluid delivery system,
a nozzle which is connected to and receives fluid from the fluid delivery system, whereby fluid is vaporised on exiting the nozzle to form an aerosol stream of fluid droplets, and
a vibration assembly which comprises
a panel-form radiator which is capable of supporting bending wave vibration and which is positioned below the aerosol stream of fluid droplets and
an electromechanical force transducer mounted to the panel-form radiator to excite vibration in the panel-form radiator so as to input vibrational energy into the droplets, wherein the transducer has an intended operative frequency range and comprises a resonant element having a frequency distribution of modes in the operative frequency range.

23. An atomiser according to claim 22, wherein the parameters of the resonant element are selected to enhance the distribution of modes in the resonant element in the operative frequency range.

24. An atomiser, comprising:
a fluid delivery system,
a nozzle which is connected to and receives fluid from the fluid delivery system, whereby fluid is vaporised on exiting the nozzle to form an aerosol stream of fluid droplets, and
a vibration assembly which comprises
a connecting stub which is mounted to the nozzle and transmits vibration to the nozzle and
an electromechanical force transducer mounted to the connecting stub to excite vibration in the connecting stub so as to input vibrational energy into the droplets, wherein the transducer has an intended operative frequency range and comprises a resonant element having a frequency distribution of modes in the operative frequency range.

25. An atomiser according to claim 24, wherein the parameters of the resonant element are selected to enhance the distribution of modes in the resonant element in the operative frequency range.
